(19) United States
(12) Patent Application Publication
(10) Pub. No.: US 2014/0369189 A1
(43) Pub. Date: Dec. 18, 2014

(54) METHOD OF CONTROLLING PACKET TRANSMISSION IN NETWORK SYSTEM AND NETWORK SYSTEM TRANSMITTING PACKET USING PSEUDO-TCP AGENT

(71) Applicant: DASAN Networks, Inc., Seongnam-si (KR)

(72) Inventor: Sangsan LEE, Seongnam-si (KR)

(21) Appl. No.: 13/920,319

(22) Filed: Jun. 18, 2013

(51) Int. Cl. H04L 12/835

(52) U.S. Cl. CPC H04L 47/30
USPC 370/230; 370/412

(57) ABSTRACT

Provided are a method of controlling packet transmission in a network system and a network system that transmits a packet using a pseudo-transmission control protocol (TCP) agent. The method includes, when a packet is received from a transmitting device or a previous router, storing, at a router, the packet in a buffer and determining whether traffic exceeds a packet processing capacity, when it is determined that the traffic exceeds the packet processing capacity, controlling, at the router, an incoming packet rate to be reduced, when a congestion window is not filled with the packet to be transmitted to a next router or a receiving device due to the reduction in the incoming packet rate, waiting, at the router, until the congestion window is fully filled with a packet received thereafter, and transmitting, at the router, the packets filling the congestion window to the next router or the receiving device.

### BACKGROUND

1. Field

The following description relates to a method of controlling packet transmission in a network system and a network system using the method.

2. Description of Related Art

Terminals that exchange information via the Internet should use the same communication protocol. Currently, TCP/IP consisting of the TCP and the IP is most generally used. TCP/IP is implemented using software in an operating system.

TCP/IP consists of the application layer, the transmission layer, the Internet layer, and the physical layer. General transmission layer protocols include a protocol such as the TCP that adjusts a transmission rate in consideration of a network state, and a protocol such as the user datagram protocol (UDP) that unconditionally transmits data without considering a network state.

The TCP is a protocol that adjusts a transmission rate in consideration of a network state. When a TCP session is established to transmit data between end terminals (clients or servers), the TCP determines the amount of data to be transmitted at a time using a TCP window size.

If an end terminal that is a data source transmits data and then no acknowledgement (ACK) message arrives before a retransmission timeout (RTO) calculated using a round-trip time (RTT) of a packet, the end terminal determines that traffic congestion has occurred in a network, and reduces a window size. Packet loss caused by network congestion results in the occurrence of the RTO, and thus the window size and the amount of data to be transmitted at a time are reduced.

Recently, while content providers (CPs) are making profit by providing service without shouldering any burden for network use, Internet service providers (ISPs) are being required to massively extend a network. For this reason, International Telecommunication Union-Telecommunication Standardization Sector (ITU-T) is trying to provide a value-added service via an intellectualized smart network and thereby improve a profit structure.

An existing network topology transmits data according to an end-to-end network mechanism (ETEM). The data is transmitted from a transmitting end terminal to a receiving end terminal via a plurality of routers and an Internet network. In this case, the data goes through the physical layer, the data link layer, and the network layer according to the open systems interconnection (OSI) model. The network layer serves to route the data via the network. The data link layer manages an interface and a device driver for exchanging information with physical elements of the network. The physical layer consists of physical parts of the network. For example, the physical layer includes a serial cable, a parallel cable, Ethernet, a token ring, an antenna, a connector, and so on. Each router sets a path of the data according to a destination address of the data.

In an end-to-end connection, a TCP algorithm is implemented by a TCP transmitting terminal and a TCP receiving terminal. The TCP transmitting terminal transmits data in sequence, controls a transmission rate, and retransmits the data when packet loss occurs. The TCP receiving terminal transmits an ACK message of a received packet to the TCP transmitting terminal to acknowledge reception of a packet.

### SUMMARY

In one general aspect, there is provided a method of controlling packet transmission in a network system, the method including: when a packet is received from the transmitting device or a previous router, storing, at the router, the packet in a buffer and determining whether traffic exceeds a packet processing capacity; when it is determined that the traffic exceeds the packet processing capacity, controlling, at the router, an incoming packet rate to be reduced; when a congestion window is not filled with the packet to be transmitted to a next router or the receiving device due to low transmission rate of the incoming packet, waiting, at the router, until the congestion window is fully filled with a packet received thereafter; and transmitting, at the router, the packets filling the congestion window to the next router or the receiving device.

The controlling of the incoming packet rate may be performed by delaying, at the router, transmission of an acknowledgement (ACK) message acknowledging reception of the packet to the transmitting device or the previous router.

The controlling of the incoming packet rate may be performed by transmitting, at the router, a notification message for reducing an outgoing packet rate to the transmitting device or the previous router.

The method may further include when the packet is received from the transmitting device or the previous router, transmitting an acknowledgement (ACK) signal to the transmitting device or the previous router.

The method may further include after the transmitting of the packets, waiting, at the router, for an acknowledgement (ACK) signal from the receiving device or the next router.

The method may further include resetting, at the router, a size of the congestion window according to a congestion state of the network system.

In another aspect, there is provided a network system transmitting a packet using a pseudo-transmission control protocol (TCP) agent, the network system including: a transmitting end terminal configured to transmit a packet; a receiving end terminal configured to finally receive the packet; and a router configured to store the packet received from the transmitting end terminal in a buffer, and transmit the stored packet to the receiving end terminal using the pseudo-TCP agent.

The pseudo-TCP agent transmits an acknowledgement (ACK) message to the transmitting end terminal when the packet is received from the transmitting end terminal, and retransmits the stored packet to the receiving end terminal when the packet received from the transmitting end terminal is lost.

In connection establishment stage, the pseudo-TCP agent intercepts a synchronization message transmitted from the transmitting end terminal, and transmits an ACK message to the transmitting end terminal.

When the packet received from the transmitting end terminal is lost, the pseudo-TCP agent transmits a negative ACK (NACK) message to the transmitting end terminal in order to retransmit the lost packet.

The pseudo-TCP agent sets a size of a congestion window for packet transmission on the basis of availability of the buffer and a network congestion state.

The pseudo-TCP agent stores the packet received from the transmitting end terminal in the buffer, and determines whether or not traffic exceeds a packet processing capacity.

When it is determined that the traffic exceeds the packet processing capacity, the pseudo-TCP agent delays transmission of the ACK message acknowledging reception of the packet to the transmitting end terminal, or transmits a notification message for reducing an outgoing packet rate to the transmitting end terminal.

When there are no packets or not enough packets to fill a congestion window in the buffer due to the transmission delay of the ACK message or the reduction in the outgoing packet rate, the pseudo-TCP agent stops packet transmission until the congestion window is filled.

In yet another general aspect, there is provided a network system transmitting a packet using a pseudo-transmission control protocol (TCP) agent, the network system including: a transmitting end terminal configured to transmit a packet; a first router configured to store the packet received from the transmitting end terminal in a buffer, and control transmission of the stored packet using a first pseudo-TCP agent; and a second router configured to store the packet received from the first router in a buffer, and control transmission of the stored packet to a next node using a second pseudo-TCP agent.

The first pseudo-TCP agent transmits an acknowledgement (ACK) message to the transmitting end terminal when the packet is received from the transmitting end terminal, and requests the transmitting end terminal to retransmit the packet when the packet received from the transmitting end terminal is lost.

The second pseudo-TCP agent transmits an ACK message to the first router when the packet is received from the first router, and requests the first router to retransmit the packet when the packet received from the first router is lost.

The first pseudo-TCP agent determines whether or not traffic exceeds a packet processing capacity, and when it is determined that the traffic exceeds the packet processing capacity, the first pseudo-TCP agent delays transmission of the ACK message acknowledging reception of the packet to the transmitting end terminal, or transmits a notification message for reducing an outgoing packet rate to the transmitting end terminal.

The second pseudo-TCP agent determines whether or not traffic exceeds a packet processing capacity, and when it is determined that the traffic exceeds the packet processing capacity, the second pseudo-TCP agent delays transmission of the ACK message acknowledging reception of the packet to the first router, or transmits a notification message for reducing an outgoing packet rate to the first router.

### BRIEF DESCRIPTION OF THE DRAWINGS

FIG. 1 illustrates an example of a network topology including a pseudo-transmission control protocol (TCP) agent.

FIG. 2 illustrates an example of a location of a pseudo-TCP agent in a network.

FIG. 3 illustrates an example of a connection establishment procedure between pseudo-TCP agents.

FIG. 4 illustrates an example of a data transmission procedure of a pseudo-TCP agent between a previous agent and a next agent connected to the pseudo-TCP agent.

FIG. 5 is a flowchart illustrating an example of TCP flow control.

FIG. 6 is a graph for simulation results of the probability of failure in a network by applying segment-by-segment transmission mechanism (SBSM) and an existing network that run based on end-to-end transmission mechanism (ETEM), and

FIG. 7 is a graph for simulation results of the number of traversed routers that a packet goes through in the SBSM and the existing ETEM.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. Also, descriptions of well-known functions and constructions may be omitted for increased clarity and conciseness.

The presently described examples will be understood by reference to the drawings, wherein like parts are designated by like numerals throughout. The drawings are not necessarily drawn to scale, and the size and relative sizes of the layers and regions may have been exaggerated for clarity.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, components, and/or groups thereof, but do not preclude the presence or addition of one or more other features, integers, steps, operations, elements, components, and/or groups thereof.

Before starting detailed explanations of figures, components that will be described in the specification are discriminated merely according to functions mainly performed by the components or conventionally carried out according to common knowledge of related technical fields. That is, two or more components which will be described later can be integrated into a single component. Furthermore, a single component which will be explained later can be separated into two or more components. Moreover, each component which will be described can additionally perform some or all of a function executed by another component in addition to the main function thereof. Some or all of the main function of each component which will be explained can be carried out by another component. Accordingly, presence/absence of each component which will be described throughout the specification should be functionally interpreted.

A transmission control protocol (TCP) transmitting terminal transmits data in sequence, controls a transmission rate, and retransmits the data when packet loss occurs. A TCP receiving terminal transmits an acknowledgement (ACK) message of a received packet to the TCP transmitting terminal to acknowledge reception of a packet. The existing network structure has problems that overall packet transmission time increases and resources on the network are wasted.

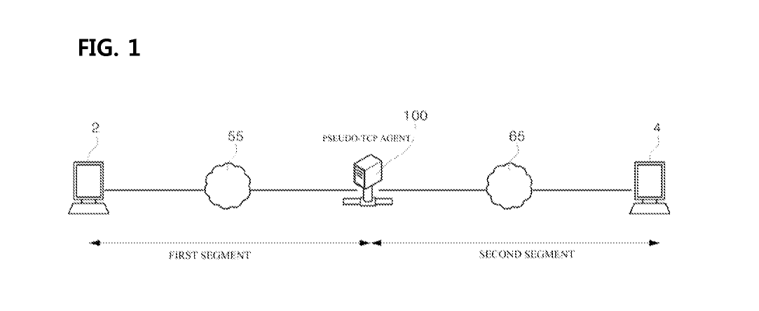

FIG. 1 illustrates an example of a network topology including a pseudo-TCP agent.

Referring to FIG. 1, a network topology including a pseudo-TCP agent according to an exemplary embodiment of the present invention transmits data according to a segment-by-segment transmission mechanism (SBSM). Data transmission and reception is performed between end terminals 2 and 4. It is assumed that the data is transmitted from the transmitting end terminal 2 to the receiving end terminal 4 via a plurality of routers in internet networks 55 and 65.

A pseudo-TCP agent 100 divides a data path into at least two individual segment. In FIG. 1, the pseudo-TCP agent 100 is located in the middle of the data path and divides the data path into a first segment and a second segment. When a packet is lost in the second segment, the lost packet is retransmitted from the pseudo-TCP agent 100 instead of the transmitting end terminal 2.

The pseudo-TCP agent 100 may be implemented in network equipment such as an edge router. The pseudo-TCP agent 100 performs packet retransmission that is performed by a transmitting terminal upon occurrence of packet loss, and performs transmission of an ACK message that is performed by a receiving terminal upon reception of a packet. In other words, a lost packet is retransmitted by the pseudo-TCP agent 100 instead of a transmitting terminal.

On a network, the pseudo-TCP agent 100 may be located at any edge position between the end terminals 2 and 4.

As shown in FIG. 1, one segment is set between the transmitting end terminal 2 and the pseudo-TCP agent 100, and another segment is set between the pseudo-TCP agent 100 and the receiving end terminal 4.

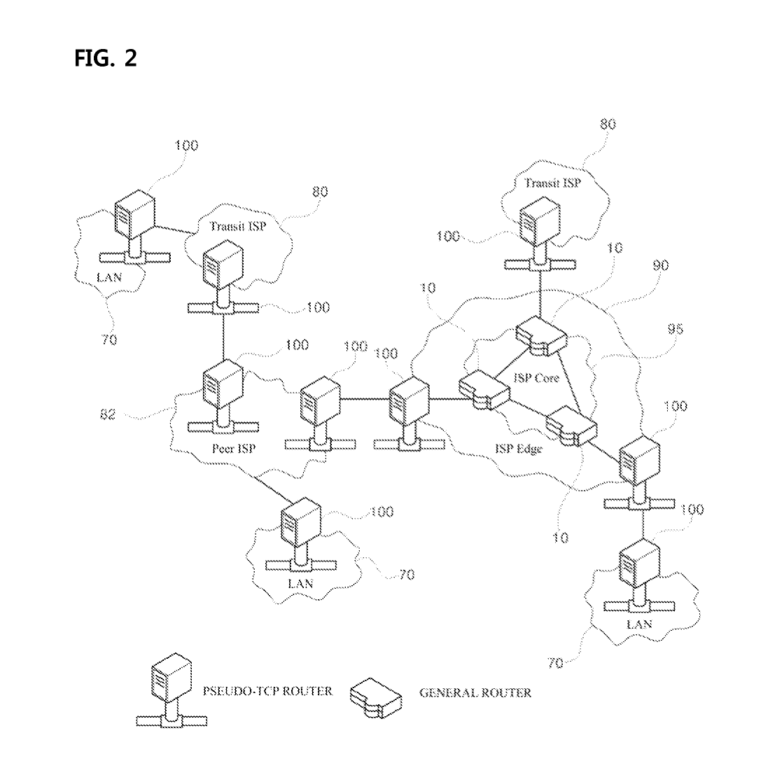

FIG. 2 illustrates an example of a location of a pseudo-TCP agent in a network. As shown in FIG. 2, a segment may be set between a pseudo-TCP agent 100 and another pseudo-TCP agent 100 as well as between an end terminal and a pseudo-TCP agent 100.

In FIG. 2, a pseudo-TCP agent 100 is implemented in an edge router. The pseudo-TCP agent 100 may be implemented in an edge router on a local area network (LAN) 70, and implemented in an edge router on a transit Internet service provider (ISP) 80 or a peer ISP 82. Alternatively, the pseudo-TCP agent 100 may be implemented in an edge router in an ISP edge domain. The implementation is only needed in the edge network equipment, there is no modification is needed in operation of a TCP transmitter or a TCP receiver requires no modification.

The pseudo-TCP agent 100 intercepts and processes a TCP packet, and forwards the processed packet to the next pseudo-TCP agent. Connection establishment, data transmission, and connection close procedures performed by the pseudo-TCP agent 100 will be described below.

When a plurality of segments are set on a network path, a connection establishment process is individually processed in the respective segments. Each of the segments establishes separate communication between its end positions.

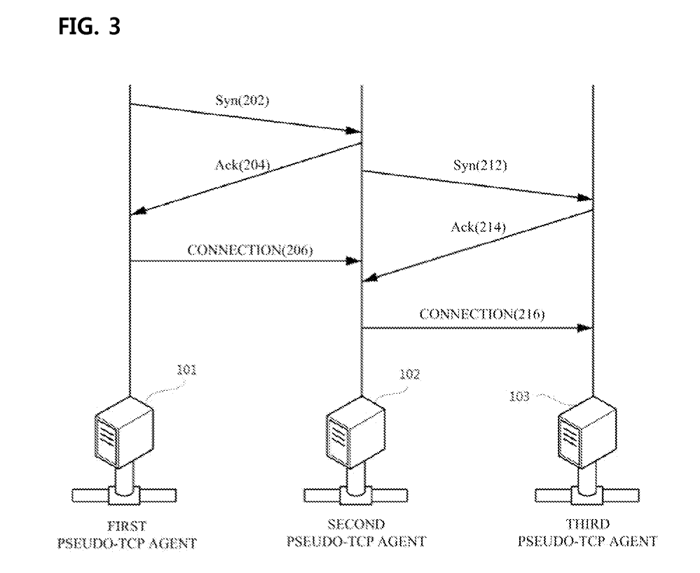

FIG. 3 illustrates an example of a connection establishment procedure between pseudo-TCP agents according to an exemplary embodiment of the present invention. In order of receiving a packet, pseudo-TCP agents are referred to as a first pseudo-TCP agent 101, a second pseudo-TCP agent 102, and a third pseudo-TCP agent 103.

The second pseudo-TCP agent 102 intercepts a synchronization message Syn transmitted by the first pseudo-TCP agent 101 (step 202). Immediately after this, the second pseudo-TCP agent 102 transmits an ACK message Ack to the first pseudo-TCP agent 101 (step 204). At the same time as this or at almost the same time as this, the second pseudo-TCP agent 102 transmits a synchronization message Syn to the third pseudo-TCP agent 103 (step 212). Then, the third pseudo-TCP agent 103 transmits an ACK message Ack to the second pseudo-TCP agent 102 (step 214).

Through this process, a connection is established between the second pseudo-TCP agent 102 and the first pseudo-TCP agent 101 (step 206), and a connection is established between the second pseudo-TCP agent 102 and the third pseudo-TCP agent 103 (step 216).

A data transmission process in each segment is started after a connection establishment is completely finished. When there is any problem in transmitting or receiving a packet, a pseudo-TCP agent needs to handle the problem immediately. For example, when the third pseudo-TCP agent 103 receives no message, the second pseudo-TCP agent 102 transmits a negative acknowledgement (NACK) message to the first pseudo-TCP agent 101 to notify the first pseudo-TCP agent 101 that a packet has not been correctly received and retransmission is necessary. If no connection is established even after a plurality of times of retransmission, a notification message that closes the connection needs to be transmitted to all pseudo-TCP agents on the data path.

By transmitting ACK messages of all packets received from the first pseudo-TCP agent 101 or a previous node, the second pseudo-TCP agent 102 operates as a destination host of a previous agent. Also, by executing TCP flow control, error detection, and congestion control algorithms, the second pseudo-TCP agent 102 operates similar to a source host for the next segment.

FIG. 3 shows an example of a connection establishment procedure between pseudo-TCP agents, and a similar procedure is performed between an end terminal and a pseudo-TCP agent.

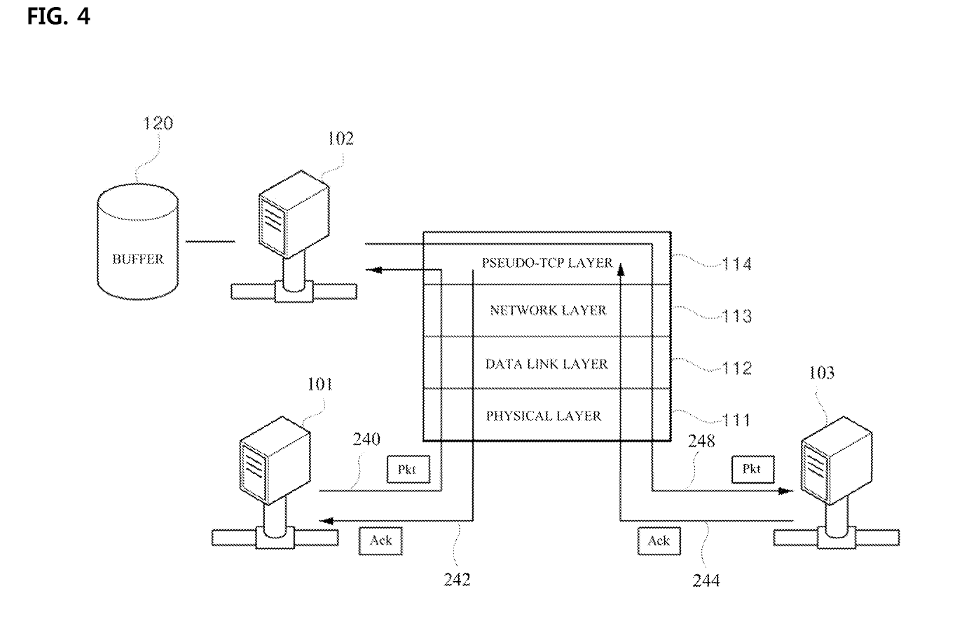

FIG. 4 illustrates an example of a data transmission procedure of a pseudo-TCP agent between a previous agent and a next agent connected to the pseudo-TCP agent. As in FIG. 3, in order of receiving a packet, pseudo-TCP agents are referred to as a first pseudo-TCP agent 101, a second pseudo-TCP agent 102, and a third pseudo-TCP agent 103.

The second pseudo-TCP agent 102 receives a TCP packet first, classifies the received TCP packet Pkt according to a protocol field of an Internet protocol (IP) header, and stores the received TCP packet Pkt in a buffer 120 (step 240). The second pseudo-TCP agent 102 transmits a first ACK message acknowledging that the packet has been correctly received in sequence to the first pseudo-TCP agent 101 (step 242).

Next, the second pseudo-TCP agent 102 updates a last ACK message number on the basis of a received ACK message, and resets a congestion window size. Finally, the second pseudo-TCP agent 102 transmits the packet Pkt stored in the buffer 120 to the third pseudo-TCP agent 103 (step 248). The third pseudo-TCP agent 103 transmits a second ACK message acknowledging that the packet has been correctly received in sequence to the second pseudo-TCP agent 102 (step 242).

In this data transmission procedure of the second pseudo-TCP agent 102, steps 242 and 244 may be simultaneously performed.

According to the related art, a packet is routed through a physical layer 111, a data link layer 112, and a network layer 113 in network equipment, for example, a router. On the other hand, according to an exemplary embodiment of the present invention, a packet is routed through the physical layer 111, the data link layer 112, the network layer 113, and a pseudo-TCP layer 114. The pseudo-TCP layer 114 is implemented in the pseudo-TCP agents 101, 102, and 103 according to an exemplary embodiment of the present invention.

Specifically, the second pseudo-TCP agent 102 allocates resources for a new TCP connection on the basis of current resources such as the availability of the buffer 120 and a current congestion state. A window set by a pseudo-TCP agent on the basis of a network congestion state is referred to as a congestion window.

When an outgoing packet rate is greater than an incoming packet rate, there may be no packet to be transmitted by the second pseudo-TCP agent 102. In this case, to continue data transmission, the second pseudo-TCP agent 102 should wait until a congestion window size is fully filled with a received packet. The second pseudo-TCP agent 102 reduces the congestion window size as soon as it recognizes that there is no packet to be transmitted due to congestion in a previous segment. When a serious problem occurs during data transmission, it is necessary to transmit a notification message to all TCP aware devices on a network path to close a connection. The notification message may be transmitted from source or destination nodes or a random pseudo-TCP agent by which an error has been detected. A pseudo-TCP agent should allocate fixed resources for a new connection, and control a congestion state on the basis of the allocated resources. When the incoming packet rate is greater than the outgoing packet rate, the content of the buffer exponentially increases up to the maximum capacity.

Thus, the second pseudo-TCP agent 102 should delay transmission of an ACK message that acknowledges reception of a packet to a previous node such that the incoming packet rate does not exceed a packet processing capacity dependent on allocated resources, or should transmit a notification message for reducing an outgoing packet rate to the first pseudo-TCP agent 101.

Finally, a TCP connection may be closed when a source user, a destination user, or these users transmit a close message. The close message needs to be detected by all pseudo-TCP aware devices on a data path to release allocated resources.

FIG. 4 illustrates an example of a data transmission procedure between pseudo-TCP agents, and the same procedure is performed between an end terminal and a pseudo-TCP agent. Consequently, FIGS. 3 and 4 illustrate examples of operation (1) between a previous node (an end terminal or a pseudo-TCP agent) and a pseudo-TCP agent and (2) between a pseudo-TCP agent and a next node (an end terminal or a pseudo-TCP agent).

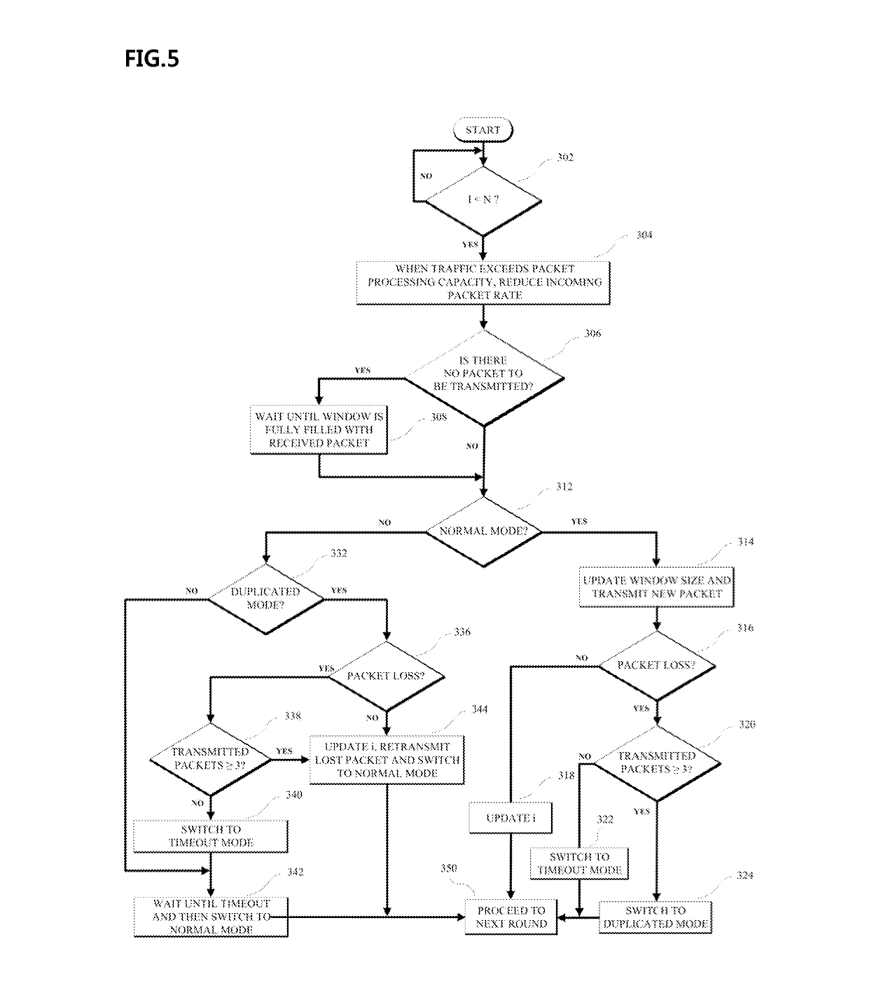

FIG. 5 illustrates TCP flow control according to an exemplary embodiment of the present invention.

In FIG. 5, it is assumed that N packets are transmitted between two end terminals. Referring to FIG. 5, when N packets should be transmitted between two end terminals in a number of rounds, a pseudo-TCP agent 100 determines whether a currently-received packet (i^{th} packet) is an N^{th} packet (step 302).

The pseudo-TCP agent 100 receives packets beginning with a 0^{th} packet. When the packet currently received by the pseudo-TCP agent 100 is the N^{th} packet, all N packets have been already transmitted from a transmitting end terminal, and the corresponding round should be finished.

When traffic exceeds a packet processing capacity, the pseudo-TCP agent 100 reduces an incoming packet rate (step 304). Specifically, when the incoming packet rate is greater than an outgoing packet rate, the pseudo-TCP agent 100 delays transmission of an ACK message that acknowledges reception of a packet to a previous node (an end terminal or a pseudo-TCP agent), or transmits a notification message for reducing an outgoing packet rate to the previous node.

Subsequently, the pseudo-TCP agent 100 determines whether there is no packet to be transmitted to a next node (an end terminal or a pseudo-TCP agent) in a buffer 120 of the pseudo-TCP agent 100 (step 306). When the outgoing packet rate becomes greater than the reduced incoming packet rate, the pseudo-TCP agent 100 has no packet to transmit. Having no packet to transmit denotes a case in which there are not enough packets to fill a current congestion window. When there are no packets or not enough packets to be transmitted to the next node, the pseudo-TCP agent 100 waits until the congestion window is fully filled with received packets (step 308).

When congestion occurs, the TCP uses the congestion window to control the congestion. When packet loss occurs due to network congestion, the TCP adjusts the size of the congestion window to be reduced, thereby causing a transmitting side to slowly transmit a packet. When no loss occurs and there are remaining resources, the TCP increases the size of the congestion window to rapidly transmit a packet, thereby controlling a congestion state.

When the congestion window is fully filled with received packets, the pseudo-TCP agent 100 determines whether a current mode is a normal mode in step 312. The normal node denotes a case in which packets are transmitted normally without loss. Also, a duplicated mode denotes a case in which packet loss occurs and the corresponding packet is retransmitted to the next node.

When the current mode is the normal mode, the process proceeds to step 314, in which the pseudo-TCP agent 100 updates the congestion window size and transmits a new packet to the next node. When an ACK message is received from the next node, the pseudo-TCP agent 100 determines that there is no packet loss, and increases a packet number i (step 318), and the process proceeds to the next round (step 350).

When it is determined in step 316 that a packet has been lost, the pseudo-TCP agent 100 determines whether the number of transmitted packets is three or more (step 320). When the number of transmitted packets is three or more, the process proceeds to step 324, and the pseudo-TCP agent 100 switches to the duplicated mode. On the other hand, when the number of transmitted packets is less than three, the pseudo-TCP agent 100 finishes the corresponding round and performs the round again.

Meanwhile, when it is determined in step 312 that the current mode is not the normal mode, the pseudo-TCP agent 100 determines whether the current mode is the duplicated mode (step 332). When the current mode is the duplicated mode, the pseudo-TCP agent 100 determines whether packet loss occurs in step 336. When no packet loss occurs, the pseudo-TCP agent 100 updates a packet number, retransmits a lost packet, and switches to the normal mode (step 344). On the other hand, when packet loss occurs, the pseudo-TCP agent 100 determines whether the number of transmitted packets is three or more (step 338). When the number of transmitted packets is three or more, the pseudo-TCP agent 100 updates a packet number, retransmits lost packets, and switches to the normal mode (step 344). On the other hand, when the number of transmitted packets is less than three, the pseudo-TCP agent 100 switches to a timeout mode (step 340). Subsequently, the pseudo-TCP agent 100 waits until a timeout, switches to the normal mode (step 342), and then starts the next round (step 350).

When it is determined in step 332 that the current mode is not the duplicated mode, the pseudo-TCP agent 100 recognizes the current mode is the timeout mode. When it is determined that the current mode is the timeout mode, the pseudo-TCP agent 100 waits until a timeout, switches to the normal mode (step 342), and then performs the next round (step 350).

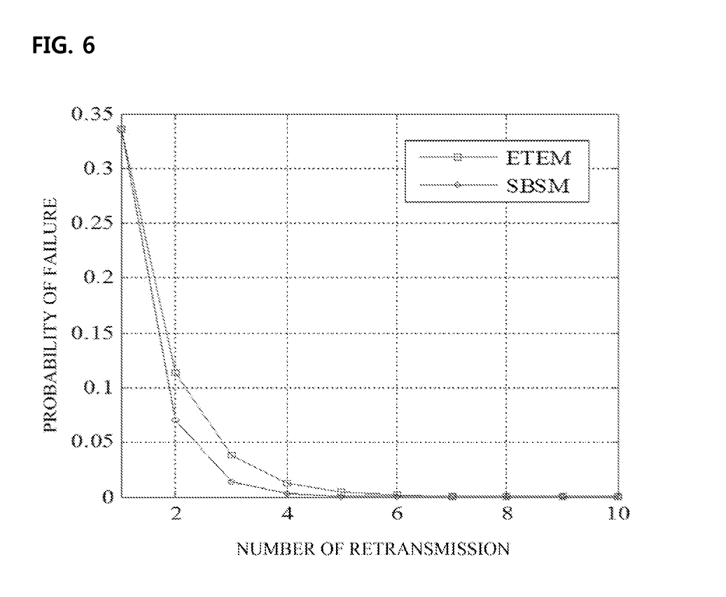

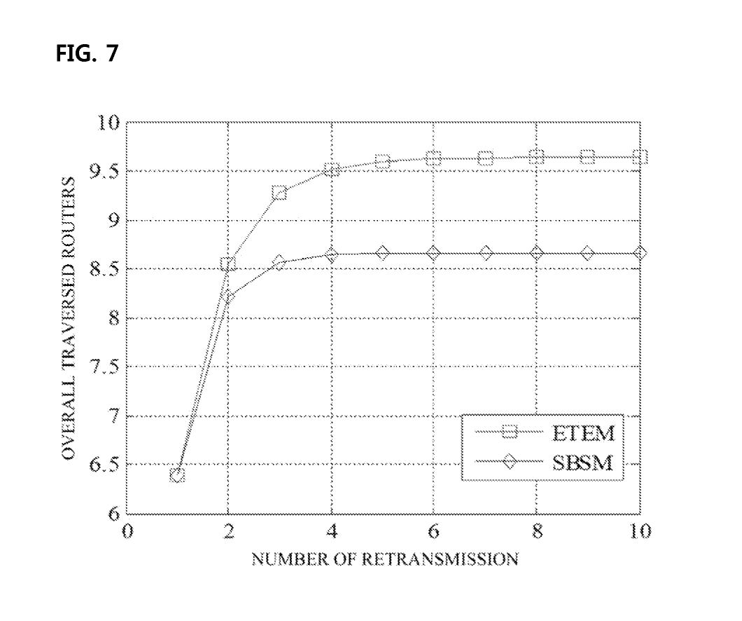

FIG. 6 and FIG. 7 are graphs showing performance comparisons between the SBSM according to an exemplary embodiment of the present invention and an end-to-end transmission mechanism (ETEM). FIG. 6 is a graph showing simulation results of the probability of failure in the SBSM and the existing ETEM. FIG. 7 is a graph showing simulation results of the number of traversed routers that a packet goes through in the SBSM and the existing ETEM.

As shown in FIG. 6, it is possible to know that the results of simulating the number of times of retransmission are noticeably reduced in the SBSM. Also, as shown in FIG. 7, it is possible to know that the number of network resources related to retransmission is reduced in the SBSM.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of controlling packet transmission in a network system including a transmitting device, routers, and a receiving device, the method comprising:
when a packet is received from the transmitting device or a previous router, storing, at the router, the packet in a buffer and determining whether traffic exceeds a packet processing capacity;
when it is determined that the traffic exceeds the packet processing capacity, controlling, at the router, an incoming packet rate to be reduced;
when a congestion window is not filled with the packet to be transmitted to a next router or the receiving device due to the low transmission rate of the incoming packet, waiting, at the router, until the congestion window is fully filled with a packet received thereafter; and
transmitting, at the router, the packets filling the congestion window to the next router or the receiving device.

2. The method of claim 1, wherein the controlling of the incoming packet rate is performed by delaying, at the router, transmission of an acknowledgement (ACK) message acknowledging reception of the packet to the transmitting device or the previous router.

3. The method of claim 1, wherein the controlling of the incoming packet rate is performed by transmitting, at the router, a notification message for reducing an outgoing packet rate to the transmitting device or the previous router.

4. The method of claim 1, further comprising, when the packet is received from the transmitting device or the previous router, transmitting an acknowledgement (ACK) signal to the transmitting device or the previous router.

5. The method of claim 1, further comprising, after the transmitting of the packets, waiting, at the router, for an acknowledgement (ACK) signal from the receiving device or the next router.

6. The method of claim 1, further comprising resetting, at the router, a size of the congestion window according to a congestion state of the network system.

7. A network system transmitting a packet using a pseudo-transmission control protocol (TCP) agent, the network system comprising:
a transmitting end terminal configured to transmit a packet;
a receiving end terminal configured to finally receive the packet; and
a router configured to store the packet received from the transmitting end terminal in a buffer, and transmit the stored packet to the receiving end terminal using the pseudo-TCP agent,
wherein the pseudo-TCP agent transmits an acknowledgement (ACK) message to the transmitting end terminal when the packet is received from the transmitting end terminal, and retransmits the stored packet to the receiving end terminal when the packet received from the transmitting end terminal is lost.

8. The network system of claim 7, wherein the pseudo-TCP agent intercepts a synchronization message transmitted from the transmitting end terminal, and transmits an ACK message to the transmitting end terminal.

9. The network system of claim 7, wherein, when the packet received from the transmitting end terminal is lost, the pseudo-TCP agent transmits a negative ACK (NACK) message to the transmitting end terminal.

10. The network system of claim 7, wherein the pseudo-TCP agent sets a size of a congestion window for packet transmission on the basis of availability of the buffer and a network congestion state.

11. The network system of claim 7, wherein the pseudo-TCP agent stores the packet received from the transmitting end terminal in the buffer, and determines whether or not traffic exceeds a packet processing capacity.

12. The network system of claim 11, wherein, when it is determined that the traffic exceeds the packet processing capacity, the pseudo-TCP agent delays transmission of the ACK message acknowledging reception of the packet to the transmitting end terminal, or transmits a notification message for reducing an outgoing packet rate to the transmitting end terminal.

13. The network system of claim 12, wherein, when there are no packets or not enough packets to fill a congestion window in the buffer due to the transmission delay of the ACK message or the reduction in the outgoing packet rate, the pseudo-TCP agent stops packet transmission until the congestion window is filled.

14. A network system transmitting a packet using a pseudo-transmission control protocol (TCP) agent, the network system comprising:
a transmitting end terminal configured to transmit a packet;
a first router configured to store the packet received from the transmitting end terminal in a buffer, and control transmission of the stored packet using a first pseudo-TCP agent; and
a second router configured to store the packet received from the first router in a buffer, and control transmission of the stored packet to a next node using a second pseudo-TCP agent.

15. The network system of claim 14, wherein the first pseudo-TCP agent transmits an acknowledgement (ACK) message to the transmitting end terminal when the packet is received from the transmitting end terminal, and requests the transmitting end terminal to retransmit the packet when the packet received from the transmitting end terminal is lost, and
the second pseudo-TCP agent transmits an ACK message to the first router when the packet is received from the first router, and requests the first router to retransmit the packet when the packet received from the first router is lost.

16. The network system of claim 15, wherein the first pseudo-TCP agent determines whether or not traffic exceeds a packet processing capacity, and
when it is determined that the traffic exceeds the packet processing capacity, the first pseudo-TCP agent delays transmission of the ACK message acknowledging reception of the packet to the transmitting end terminal, or transmits a notification message for reducing an outgoing packet rate to the transmitting end terminal.

17. The network system of claim 15, wherein the second pseudo-TCP agent determines whether or not traffic exceeds a packet processing capacity, and
when it is determined that the traffic exceeds the packet processing capacity, the second pseudo-TCP agent delays transmission of the ACK message acknowledging reception of the packet to the first router, or transmits a notification message for reducing an outgoing packet rate to the first router.
